(19) United States
(12) Patent Application Publication
(10) Pub. No.: US 2003/0163362 A1
(43) Pub. Date: Aug. 28, 2003

(54) Auto-generation of supplier forecast method

(76) Inventors: Jen Fu Lee, Taipei (TW); Jih Hong Huang, Taipei (TW); Dei Chin Lee, Taipei (TW); Hua Shan Hsu, Taipei (TW)

Correspondence Address: JACOBSON HOLMAN PLLC, 400 SEVENTH STREET N.W., SUITE 600, WASHINGTON, DC, 20004, US

(21) Appl. No.: 10/081,210

(22) Filed: Feb. 25, 2002

(51) Int. Cl. G06F 17/60

(52) U.S. Cl. 705/10

(57) ABSTRACT

An auto-generation of supplier forecast method aims at resolving the problems of unpredictable material requirements with clockwork precision by the material forecast system in the manufacturing industry. By using a forecast arithmetic server to process forecasting of material requirements at the enterprise end, the invention allows for rapid transfer of the forecast report to the suppliers and material purchasing staff, and accomplishes the operations of material issuing and purchasing. The disclosed invention at least consists of the following steps: the enterprise end receives at least one item of forecast data from a client end, the Enterprise Resource Planning (ERP) server integrates the forecasted data, the Enterprise Resource Planning (ERP) server generates a start-up order of the forecast arithmetic server, the Enterprise Resource Planning (ERP) server executes the forecast arithmetic server, the forecast arithmetic server generates a forecast report, and transfers the forecast report to supplier ends through a specified data transmission method.

### BACKGROUND OF THE INVENTION

1. Field of the Invention

The invention relates to a material requirements forecast method, and particularly a method that is utilized in the operation of material issuing and purchasing to enable the real time and two-way operation of automatically generating material forecasts of suppliers.

2. Related Art

With the development of information technology and constant expansion of business scales, product items have become more and more complicated nowadays. Restricted management of material no longer satisfies modem enterprises' requirements. Therefore, a Supply Chain Management (SCM) under integral views has been created. The most important factor above all operation costs in this Supply Chain, as well as a chief concern to manufacturing enterprises, is the material distributions, including the processes of material procurement, storage, delivery, and manufacturing.

Supply Chain Management (SCM) aims at the professional knowledge field of material distribution management, further generating Supply Chain Execution (SCE). Supply Chain Execution (SCE) integrates operations of whole supply chain, from the standpoint of the Supply Chain Management (SCM), and focuses on the “execution” side of material distribution operations under the Warehouse Management System (WMS).

The current development of B2B e-commence is mainly focused on how to merchandise on the Internet. However, daily problems in the manufacturing industry include: what parts or components need to be purchased, what specified cycle/period to purchase materials with clockwork precision, how to plan production schedules after purchasing material items, how to arrange delivery of products, how to manage excess/surplus stock, etc. For example, materials forecast by customers and formal orders are not the same thing, and even a formal order could possibly change without notice. Therefore, loss due to excess/surplus stock resulting from mistaken list making and incorrect material preparation often occurs. Present material issuing methods of the Enterprise Resource Planning (ERP) system mostly accommodate forecast orders or formal orders made by clients to place material purchasing orders to suppliers. It takes time to prepare materials and such when a supplier receives a purchase notice. The time spent and wasted is equal to the completion of productions. Moreover, the method of manual notification is subject to human error and is a malady in inventory management. In the mean while, respective suppliers maintain different data formats that waste system resources when conversion of data formats are processed for various materials.

Hence, a method of predicting materials and automatically generating forecasts of suppliers in the manufacturing industry has become a heavily focused subject.

### SUMMARY OF THE INVENTION

In view of the foregoing, the invention aims at resolving the preceding disadvantages to provide an auto-generation of supplier forecasting. Due to various product requirements of respective clients and different material provisions among vendors/suppliers, the operations of material issues and productions cannot accommodate each other within the Supply Chain Management (SCM) in the manufacturing industry. The major objective of the invention is to calculate and generate forecast reports of material requirements, and notifying material purchase staff and vendors/suppliers in a timely fashion, establishing data communication channels for both parties to avoid variations in purchasing materials. Moreover, by the disclosed data transmission method enables data formats among various vendors/suppliers in the supply chain to be easily converted into what an enterprise end needs.

The method includes at least the following steps: receiving at least one forecasted data sent from clients to the enterprise end, integrating forecasted data through the Enterprise Resource Planning (ERP) server, generating a start-up order of a forecast arithmetic server, executing the forecast arithmetic server, generating forecast reports by the forecast arithmetic server, and transferring the forecast reports to supplier ends through a specified data transmission method.

### BRIEF DESCRIPTION OF THE DRAWINGS

FIG. 1 is a schematic structure of the disclosed method.

FIG. 2 is a schematic structure of data transmission of the disclosed method.

FIG. 3-a is a flowchart of the disclosed method.

FIG. 3-b is a flowchart of the disclosed method.

FIG. 3-c is a flowchart of the disclosed method.

FIG. 4 is an exploded view of prior bills of material.

FIG. 5 is an exploded view of bills of material according to the invention.

### DESCRIPTION OF THE PREFERRED EMBODIMENT

The invention aims at providing a kind of auto-generation of supplier forecasting, particularly targeting the Supply Chain Management (SCM) and the Enterprise Resource Planning (ERP) which are presently and widely advocated in the market place. The goals of the method are to process effective utilization and management of enterprise resources and re-engineer the workflow of data transmission of a supplier to heighten efficiency and reduce operation costs of an organization. The disclosed invention employs a supplier data transmission system. It enables all messages in material purchasing and issuing operations of the system to be transferred in a timely fashion. It further utilizes Enterprise Resource Planning (ERP) to integrate effective data for quickly issuing materials from suppliers.

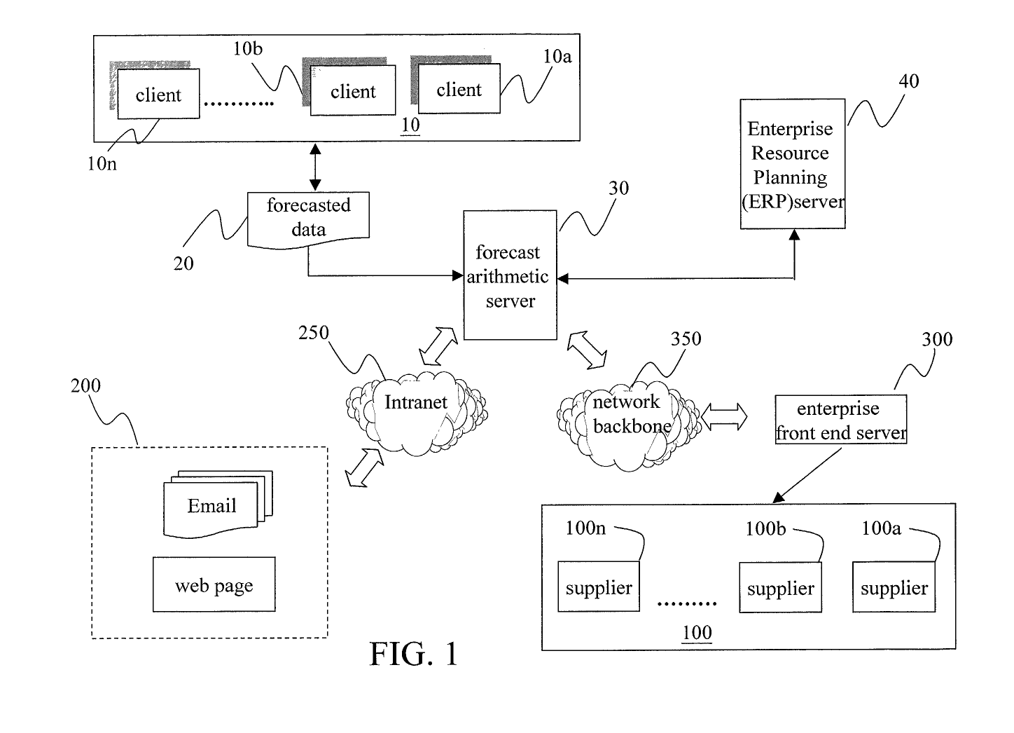

The feasibility and practicality of the invention will be elaborated by means of an embodiment depicted in the following. FIG. 1 is a schematic representation of auto-generation of the supplier forecast according to the invention. The systematic structure is described as follows.

Forecasted data 20, which are provided by a plurality of client ends 10a˜n, are integrated through Enterprise Resource Planning (ERP) and sent to the forecast arithmetic server 30 for calculation. The forecast arithmetic server 30 then generates a forecast report and transfers the report to the enterprise back end server 200 through the Intranet 250. A material purchase staff at the enterprise end then acquires the forecast report through a web query page of the internal network of the enterprise end and relevant reports attached to e-mail. The material purchase staff at the enterprise end then transfers the forecast report to the information intermediary 400 through the network backbone 350. After being integrated, the forecast report can be directly found on a network interface provided by the information intermediary 400 for supplier ends 100a˜n.

The above-mentioned network backbone 350 connects the enterprise end, supplier and the information intermediary and further processes data transmission that generalizes all network structures and types with functions of communications and data transfer.

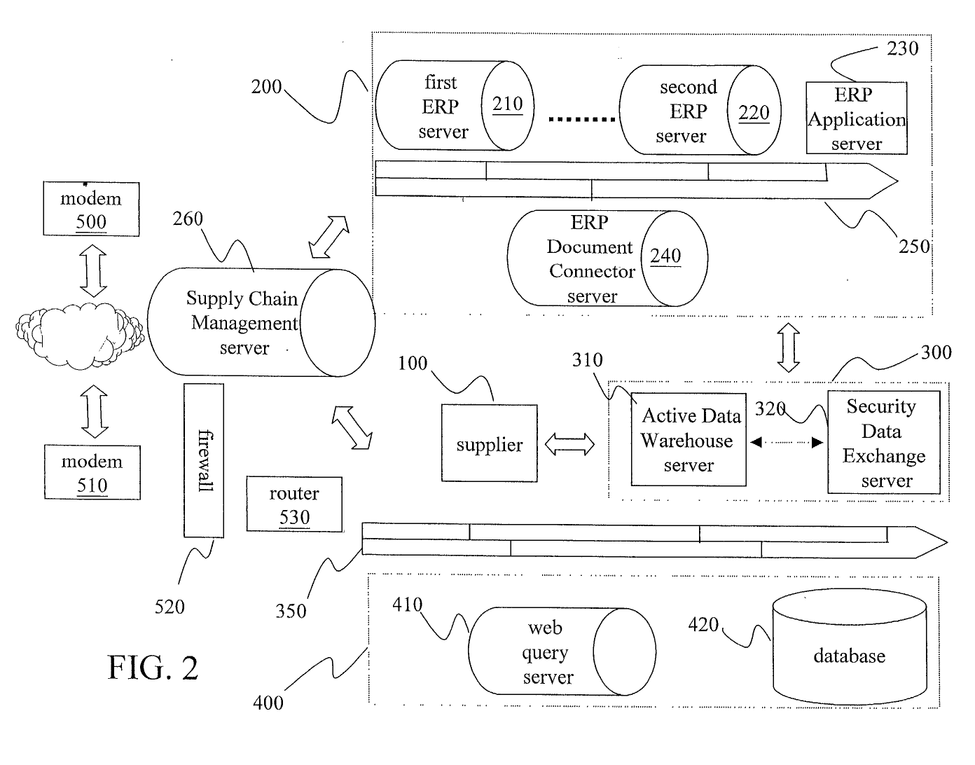

FIG. 2 illustrates the systematic structure of data transmission according to the invention. It comprises one modem 500 linking to another modem 510, both modem 500 and modem 510 may be dial-up modems, network (Local Area Network, LAN) modems, ISDN modems, cable modems or the like. It enables users to enter an Intranet 250 through the identity authentication of a Firewall 520 and a Router 530. The Router 530 is for linking two network facilities and converting data packets into data frames to select paths. The Intranet 250 is linked to a supplier end 100 and an information intermediary 400. The Intranet 250 consists of (1) an enterprise back end server 200, (2) a supply chain management (SCM) server 260, and (3) an enterprise front end server 300:

(1) The enterprise back end server 200 further includes: (a) a first end Enterprise Resource Planning (ERP) server 210, (b) a second end Enterprise Resource Planning (ERP) server 220, (c) an Enterprise Resource Planning (ERP) application server 230, and (d) an Enterprise Resource Planning (ERP) Document Connector Server 240. Their respective functions will be described as follows:

(a) The first end Enterprise Resource Planning (ERP) server 210, and (b) the second end Enterprise Resource Planning (ERP) server 220: the main function of both servers is to provide a base for the entire enterprise information system and to integrate the results. These servers integrate all operations of the enterprise, including human resources, finances, manufacturing, distribution, and communication among organizations, customers and suppliers, and assist in managing production processes and reengineering the processes.

(c) The Enterprise Resource Planning (ERP) application server 230: the main function of this server is to provide a plurality of defined fields and formats, and to store the data of the first end Enterprise Resource Planning (ERP) server 210 and the second end Enterprise Resource Planning (ERP) server 220. It also provides a function that enables supplier 100 to select any of the defined fields and formats required. In the mean while, it allows supplier 100 to define its own fields and formats when in use to enhance the portability of the Enterprise Resource Planning (ERP) application server. It also stores the fields and formats on the information intermediary 400, and enables the transmission of data back to the enterprise end after data conversion.

(d) The ERP Document Connector Server 240: the main function of this server is to enable the first end Enterprise Resource Planning (ERP) server 210 and the second end Enterprise Resource Planning (ERP) server 220 of the Enterprise Resource Planning (ERP) application server 230 to connect mutual data and documents. In the mean time, it allows the data and messages transferred back by the enterprise front end server 300 to be stored here. Thus, the system can easily analyze and abstract useful data during integration, and determine the final data storage location, or allow people in the enterprise to search and retrieve required information in the shortest possible amount of time.

The aforementioned servers (a), (b), (c) and (d) are linked to one another through an enterprise internal network (Local Area Network, LAN) 250. The LAN 250 can be an Ethernet.

(2) The supply chain management server 260: the main function of this server is to link the enterprise front end server 300, the enterprise back end server 200 and supplier 100 to one another. Moreover, it electronically manages planning and control of products and services, as well as information and money transactions through supply chain management (SCM). Therefore, the enterprise may get the right products at the right places at the minimum cost with minimum inventory and still can offer customers excellent service. Thereby it utilizes and distributes enterprise resources (such as people, equipment, materials, and capital) effectively and efficiently. The Supply Chain means a network consisting of assembled individual entities that execute the above-mentioned processes, and which transfer materials from the beginning to become finished products at the end and finally be delivered to customers.

(3) The enterprise front end server 300 consists of (a) an Active Data Warehouse (ADW) server 310 and (b) a Security Data Exchange Server 320, which are both described as follows:

(a) The ADW server 310: the main function of this server is to automatically capture data, which was input by supplier 100, from a purchase database 420 and temporarily store the data therein. After analyzing and integrating the data, the ADW server stores the captured data on the enterprise back end server 200. In the mean time, the ADW server actively captures data provided by the enterprise back end server 500 and temporarily stores it therein. It then stores the data on the information intermediary 400 after the data is analyzed and integrated.

(b) The Security Data Exchange Server 320: the main function of this server is to perform security authentication on the data and messages actively captured by the ADW server 310 before storage. This is why the ADW server 310 performs the temporarily storing process.

Supplier 100 is a supplier that may input relative materials information through the Web site provided by the information intermediary 400.

The information intermediary 400 is a third-party authentication organization that does not belong to the suppliers or the enterprises. It provides a platform for storing data of the suppliers and enterprises, and offers added value network functions. The information intermediary 400 consists of (a) a purchase order web query server 410, and (b) a purchase database 420. These are described in detail as follows:

(a) The Purchase Order Web query server 410: the main function of this server is to allow supplier 100 and enterprise end to inquire about the progress of purchase order processing on the Web site provided by the information intermediary 400. All the data are directly accessed by the database 420.

(b) The purchase database 420: the main function of this database is to enable the ADW server 310 to actively capture and store one of those customized fields and formats, which are generated by the Enterprise Resource Planning (ERP) application server 230. It allows supplier 100 to directly access the customized fields and formats from the database for data entry use. If the customized fields and formats cannot meet supplier requirements, supplier can directly modify the self-defined fields. Another function is to store data, which are transferred from the enterprise end and input by supplier 100, into the database.

According to the above, functions and processes provided by the information intermediary 400 are in the same formats, so the information intermediary 400 is unable to provide flexible fields and formats for various suppliers with the most efficiency. Therefore, the disclosed invention aims at resolving such a problem by proposing a data transfer mode by using the configure to order (CTO) concept to complete data transmission on the network based on customized fields and formats, which enable the suppliers to order/deliver materials more efficiently and easily.

The disclosed method of the invention is to place conventional data transfer concepts and architecture on the Web. It mainly employs the techniques of Enterprise Resource Planning (ERP), Supply Chain Management (SCM) and Information Intermediary to achieve the function of integrating diverse data and transferring data in a timely fashion. It can be used between the suppliers and the enterprise end in the supply chain to enable the suppliers to actively receive data, and to directly transfer effective information according to users' requirements. In the mean time, it can also work in reverse by sending effective in formation from the suppliers to the enterprise end. It further establishes a data transfer unit at a third-party authentication organization between suppliers and the enterprise end to facilitate data transfer.

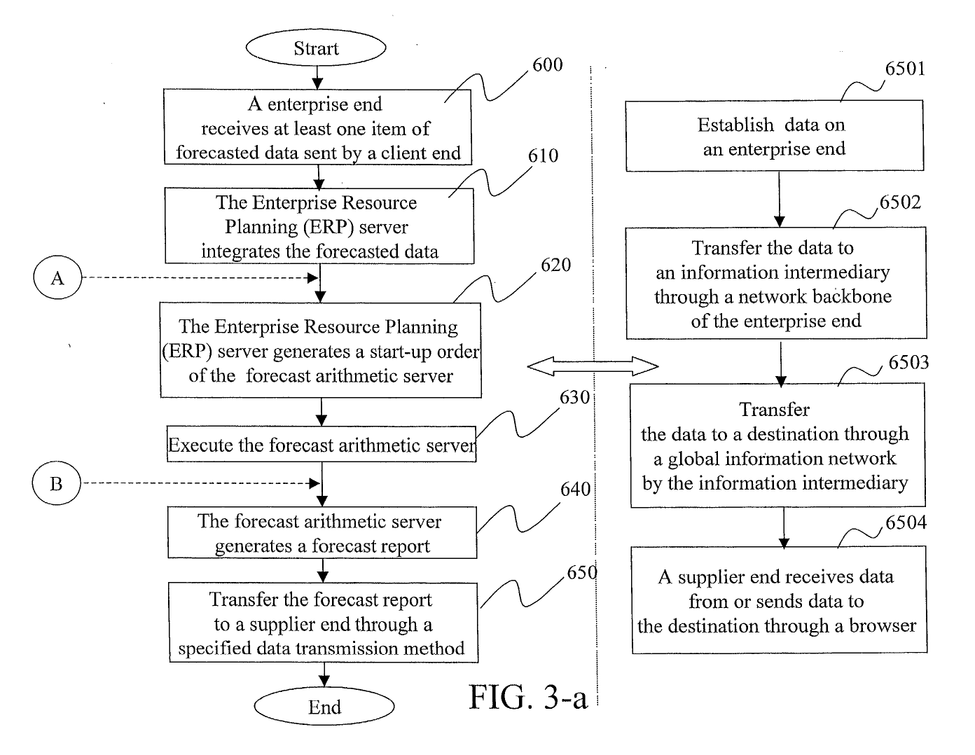

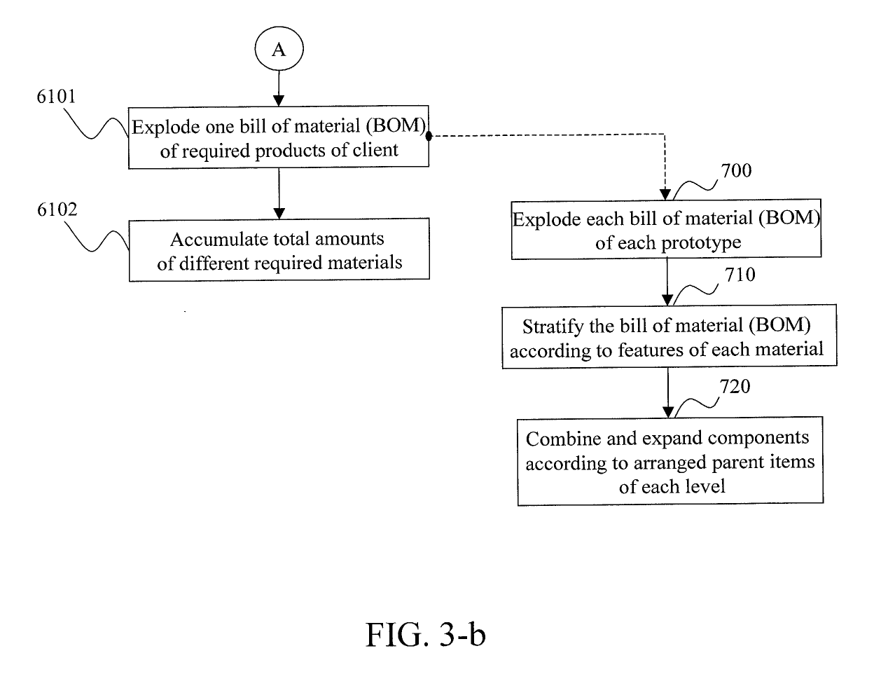

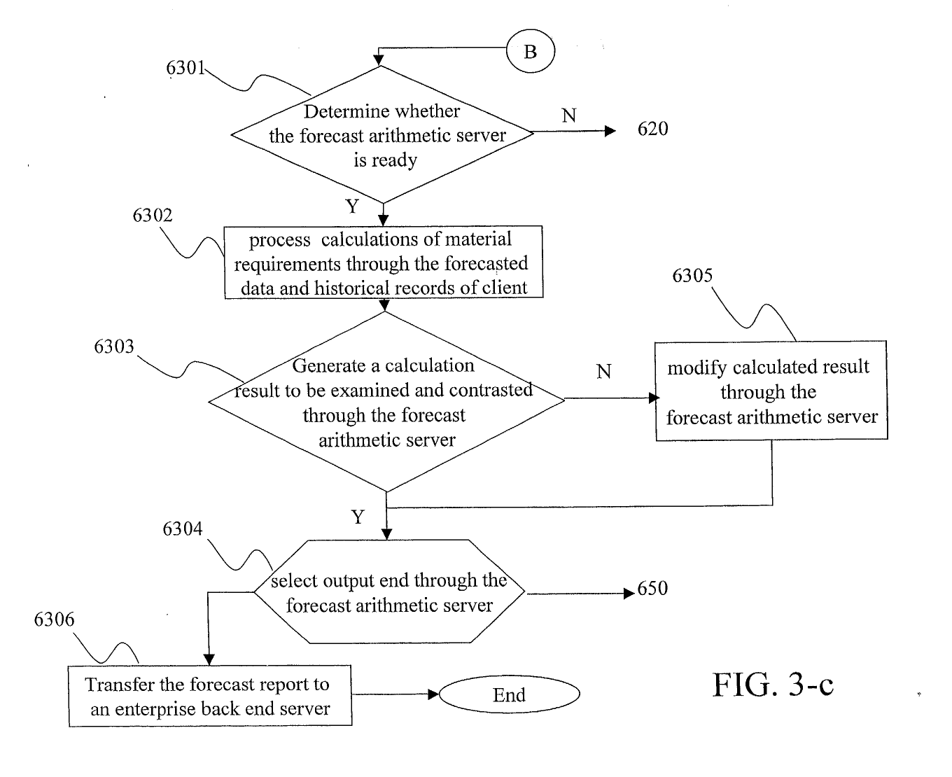

FIG. 3-a is a flowchart of auto-generation of supplier forecasting according to the invention. The details are described as follows.

First, an enterprise end receives at least one item of forecasted data transferred from a client end 10 (step 600). The Enterprise Resource Planning (ERP) server 40 then integrates the forecasted data (step 610). The detailed flow of integrating the forecasted data through the Enterprise Resource Planning (ERP) server 40 goes to process symbol A in FIG. 3-b. The Enterprise Resource Planning (ERP) server 40 further generates a start-up order of a forecast arithmetic server 30 (step 620), and executes the forecast arithmetic server 30 (step 630). The detailed flow of executing the forecast arithmetic server 30 goes to process symbol B in FIG. 3-c. After being calculated, a forecast report is generated by the forecast arithmetic server 30 (step 640) and sent to a supplier end 100 through a specified data transmission method (step 650). It then ends the process flow.

The above-mentioned forecast arithmetic server 30 and the Enterprise Resource Planning (ERP) server 40 connect to each other through an Intranet 250. The LAN 250 may be an Ethernet. The aforementioned forecasted data provides a plurality of columns/fields to store relevant data of required goods from client. It is generated based on a specified cycle/period, which is defined by client, according to different products.

FIG. 3-b is a flowchart of auto-generation of supplier forecasting according to the invention. Refer to process symbol A in FIG. 3-b, the details of which are described as follows.

First, it explodes a bill of material (BOM) of required products by client (step 6101). The Enterprise Resource Planning (ERP) server 40 then accumulates the total amount of various required materials (step 6102), and then returns to step 620.

The way of exploding bills of material (BOM) mentioned by step 6101 is a kind of quicker exploding method. It consists of the following steps: first, exploding all bills of material (BOM) of respective prototypes (step 700), stratifying the bills of material (BOM) according to the features of each material (step 710), and finally combining and expanding the components or parts according to arranged parent items of each level (step 720).

FIG. 3-c is a flowchart of auto-generation of supplier forecasting according to the invention. Refer to process symbol B in FIG. 3-c, the details of which are described as follows.

First, the Enterprise Resource Planning (ERP) servers 40 determines whether the forecast arithmetic server 30 is ready (step 6301). If it is not, the process returns to step 620. If the forecast arithmetic server 30 is ready, it proceeds with calculations of material requirements according to the forecasted data and historical records of client (step 6302). If the examination is correct, the forecast arithmetic server 30 selects an output end (step 6304) or modifies the calculated result (step 6305). When the modified result is generated, the process goes to step 6304. When the forecast arithmetic server 30 chooses to enter data into the enterprise end, the forecast report is sent to an enterprise back end server (step 6306). When the forecast arithmetic server 30 chooses to input data into supplier 100, the process goes to step 650.

The aforementioned step 6306 is to send the forecast report to material purchasing staff of the enterprise end to support communications with supplier based on corresponding data between both parties. The data transmission method can be a web query page through an internal network of the enterprise end and relevant reports attached to e-mail.

The above-mentioned forecast report relates to a schedule of required material issuing from supplier. It consists at least of the following categories: a material item, a material quantity and expiry date.

Returning to FIG. 3-a, the specified data transmission method mentioned in step 650 relates to the following process: first, establish data on an enterprise end 40 (step 6501). The enterprise end 40 includes an enterprise front end server 300, an enterprise back end server 200 and a Supplier Chain Management (SCM) server 260. The established data is stored on an ERP document connector server 240 to generate different required information through several Enterprise Resource Planning (ERP) servers 40. The enterprise end, therefore, transfers the data to an information intermediary 400 through a network backbone 350 (step 6502). The enterprise end utilizes information generated by the Enterprise Resource Planning (ERP) server 40, transferring the data to the information intermediary 400 through the network backbone 350 based on a File Transfer Protocol (FTP). The information intermediary 400 stores the data on a database 420 and transfers the data to a destination end through a global information network (step 6503) for relevant and specified suppliers to browse. One supplier end 100 accesses and receives data through a browser (step 6504) to achieve the object of data transmission.

Before transferring data from the enterprise end to the information intermediary 400, the enterprise end first sets up a data converter and a data convert engine between the enterprise end and the information intermediary 400. The data convert engine is located in the data converter. When data are transferred to the information intermediary 400 through the data converter, it links to a function library through the data convert engine. The function library converts the data into formats required by different suppliers to complete the process of format conversion. The process then returns to step 6502 to process the rest of steps. Hence, based on such a method of data format conversion set forth above, different data formats can be customized to meet the requirements of different suppliers, to thereby achieve the object of converting data formats in a configure-to-order fashion.

The aforementioned step 6502 of transferring the data to the information intermediary 400 through the network backbone 350 from the enterprise end further converts the data into required formats through the data converter. The data converter utilizes the concept of configure-to-order (CTO) to convert data/information in the network and set up various tables and fields/columns according to the requirements of different supplier ends.

The aforementioned destination end is a platform provided by the information intermediary 400 to store data from both supplier ends and enterprise ends.

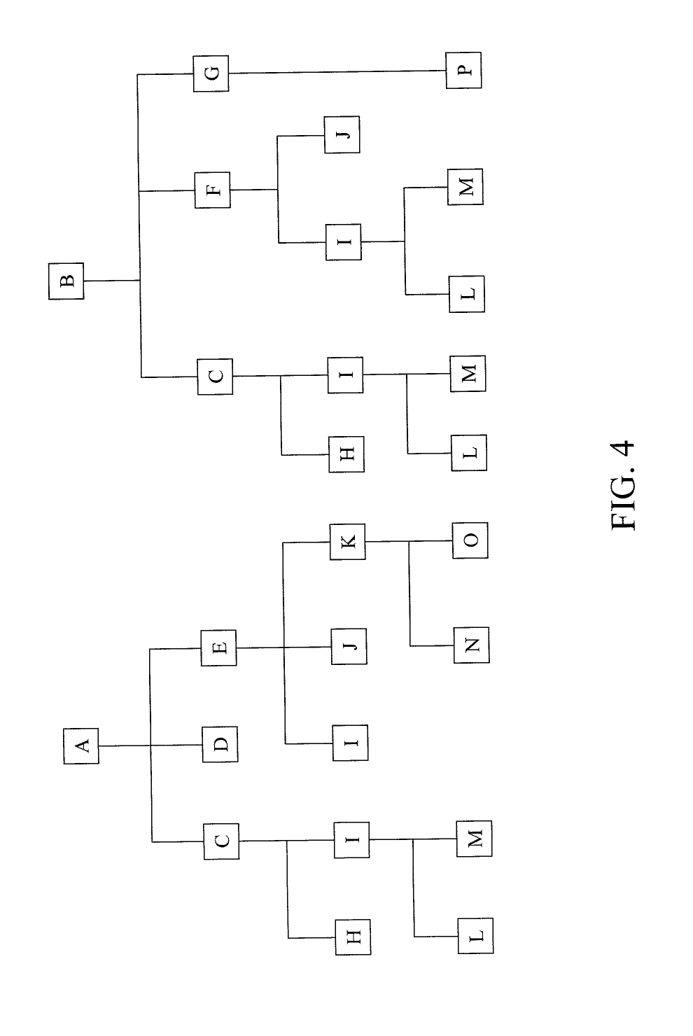

FIG. 4 is an exploded view of presently known bills of material (BOM) that illustrates the method of exploding bills of material (BOM).

First, the system explodes the first level of a bill of material (BOM) of prototype A (material modules C, D, and E), then explodes the second level (material modules H, I, I, J, and K). At the second level of the bill of material (BOM) there is a material module I that is repeatedly exploded, since material module I belongs to the parent material module C, and also belongs to the parent material module E. Finally, the system drills down to the third level (material modules L, M, N, and O). At the third level of the bill of material (BOM) there are material modules L and M that are repeatedly exploded, as both L and M belong to the parent material module I, which is one of the sub-components of parent material modules C and E.

After prototype A is exploded, the system explodes the first level of the bill of material (BOM) of prototype B (material modules C, F, and G), then explodes the second level (material modules H, I, I, and J). At the second level of the bill of material (BOM) there is a material module I that is repeatedly exploded, since material module I belongs to the parent material module C, and also belongs to the parent material module E. Finally, the system drills down the third level (material modules L, M, L, M, and P). At the third level of the bill of material (BOM) there are material modules L and M that are repeatedly exploded, as both L and M belong to the parent material module I, which is one of the sub-components of parent material modules C and E.

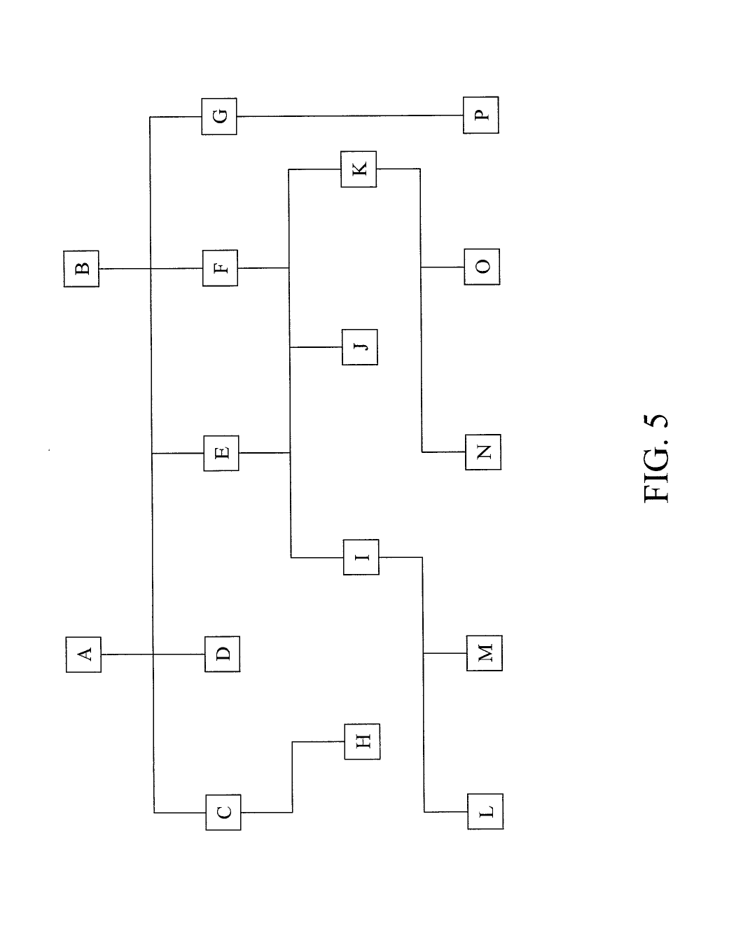

FIG. 5 is an exploded view of bills of material (BOM) according to the disclosed invention that illustrates the method of exploding bills of material (BOM) as follows:

The exploding method of the invention: first, the system explodes all bills of material (BOM) of respective prototypes (prototype A and B, for example), then it combines and explodes the first level of the bills of material (BOM) of both prototypes A and B (material modules C, D, E, F, and G). After the first level is exploded, the system drills down to the second level to combine and explode the bills of material (BOM) of both prototypes A and B (material modules H, I, J, and K). After the second level is exploded, the system drills down to the third level to combine and explode the bills of material (BOM) of both prototypes A and B (material modules L, M, N, O, and P).

Therefore, the method of exploding bills of material (BOM) consists of the following steps: first, explode all bills of material (BOM) of respective prototypes, then stratify all levels of the bills of material (BOM) to assemble features of the respective prototypes, finally, Combine and explode components or parts at each level from all integrated bills of material (BOM).

This method of exploding can greatly reduce the burden to system resources, enhance efficiency, and enable material management and distribution more effectively.

In sum, the conventional method of exploding bills of material (BOM) requires repeatedly exploding material items to match the tree structure of bills of material (BOM). Take material module M as an example. This module has been exploded four times, which heavily occupies the hardware space and wastes time for exploding. Therefore, the disclosed invention utilizes a combination of methods to explode bills of material (BOM), and achieves the following advantages:

1) each material is exploded once to save time for exploding bills of material (BOM);

2) common materials of respective prototypes are easily understood;

3) it saves resources of the information system;

4) it reduces the time needed for searching material modules (prototypes only need to be exploded once, so it is not necessary to search various prototypes one-by-one);

5) it is not necessary to have duplicated storage, which can save memory space.

An invention in the form of a method for managing decentralized production and centralized material distribution is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. An auto-generation of supplier forecast method relates to a method that employs data provided by a client end to predict material requirements through a forecast arithmetic server in an enterprise end server, and further connects to the Internet to transfer updated information to a supplier end to complete the operations of material provisions, the method comprising the steps of:
receiving at least one forecasted data from a client end to the enterprise end;
integrating the forecasted data through the Enterprise Resource Planning (ERP) server;
generating a start-up order of a forecast arithmetic server through the Enterprise Resource Planning (ERP) server;
executing the forecast arithmetic server;
generating a forecast report through the forecast arithmetic server; and
transferring the forecast report to a supplier through a specified data transmission method.

2. The method of claim 1, wherein the forecast arithmetic server and the Enterprise Resource Planning (ERP) server connect to each other through an enterprise Intranet which is an Ethernet.

3. The method of claim 1, wherein the forecasted data provides plurality of fields to store relevant data of required products by client, and the forecasted data is generated based on a specified cycle/period.

4. The invention as recited in claim 3, wherein the specified cycle/period is defined by client according to different products.

5. The method of claim 1, wherein the step of integrating the forecasted data through the Enterprise Resource Planning (ERP) server to convert data format of client into data format of the enterprise end further comprises the steps of:
exploding a bill of material (BOM) of required products of client; and
accumulating total amounts of required various materials.

6. The method of claim 5, wherein the method of exploding a bill of material (BOM) further comprises the steps of:
exploding all bills of material (BOM) of respective prototypes;
stratifying all the bills of material (BOM), according to assemble features of respective prototypes; and
combining and exploding components or parts at each level from all integrated bills of material (BOM).

7. The method of claim 1, wherein the step of executing the forecast arithmetic server further comprises the steps of:
evaluating if the forecast arithmetic server is ready;
proceeding calculations of material requirements according to the forecasted data and historical record of client;
generating a calculated result through the forecast arithmetic server to be examined and contrasted; and
selecting an output end through the forecast arithmetic server.

8. The method of claim 7, wherein the step of selecting an output end through the forecast arithmetic server consists of two ways: one output is to an enterprise back end server, and the other is to a supplier end.

9. The method of claim 8, wherein the output to an enterprise back end server is to transfer the forecast report to material purchase staff at the enterprise end, and it enables the material purchase staff to communicate with supplier based on corresponding data of both parties, and the data transmission way can be a web query page through an internal network of the enterprise end and attached relevant reports through an e-mail.

10. The method of claim 1, wherein the forecast report relates to a schedule of required material issuing by supplier, includes at least the following fields: a material item, a material quantity and an expiry date.

11. The method of claim 1, wherein the specified data transmission method further comprises the steps of:
establishing a data on an enterprise end;
transferring the data to an information intermediary through a network backbone by the enterprise end;
transferring the data to a destination end through a web site by the information intermediary; and
receiving/sending information at the destination end by using a browser from the supplier.

12. The method of claim 11, wherein the step of transferring the data to an information intermediary through a network backbone from the enterprise end further includes the conversion of data format through a data converter.

13. The method of claim 12, wherein the data converter is utilizing the concept of configure-to-order (CTO) to accomplish data conversion on the network with customized fields and formats established based on different requirements of suppliers.

14. The method of claim 11, wherein the network backbone is to connect among the enterprise, supplier and information intermediary and further to proceed data transmission that generalizes all network structures and types with functions of communications and data transfer.

15. The method of claim 11, wherein the destination end relates to a platform provided by the information intermediary to store data from supplier and from the enterprise end.
